(19) United States
(12) Patent Application Publication
(10) Pub. No.: US 2012/0292170 A1
(43) Pub. Date: Nov. 22, 2012

(54) TOUCH PANEL

(75) Inventors: Hsiang-Wei Yin, Taichung City (TW); Shin-Chieh Huang, Taichung City (TW); Ming-Kung Wu, Taichung City (TW); Ping-Wen Huang, Taichung City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/472,445

(22) Filed: May 15, 2012

(30) Foreign Application Priority Data
May 16, 2011 (TW) 100117041

(51) Int. Cl. H01H 1/12

(52) U.S. Cl. 200/512

(57) ABSTRACT

A touch panel having an operation area and a periphery area surrounding the operation area is provided. The touch panel includes a substrate, a touch element, a complex non-conductive layer, and a light shielding layer. The touch element is disposed on the substrate and located in the operation area. The complex non-conductive layer is disposed on the substrate and at least located within the periphery area, and formed by stacking of a plurality of non-conductive layers and any two adjacent non-conductive layers are made of different materials. The light shielding layer is disposed on the substrate and located at the periphery area, wherein the non-conductive layers are located at a side of the light shielding layer adjacent to the substrate.

### CROSS-REFERENCE TO RELATED APPLICATION

This application claims the priority benefit of Taiwan application serial no. 100117041, filed on May 16, 2011. The entirety of the above-mentioned patent application is hereby incorporated by reference herein and made a part of this specification.

### BACKGROUND OF THE INVENTION

1. Field of Invention

The present invention relates to a touch panel. More particularly, the present invention relates to a touch panel having a color border.

2. Description of Related Art

In recent years, various electronic products are developed to have features of easy operation, small size and large screen size. Particularly, requirements in sizes and screen sizes of portable electronic products are strict. Therefore, in many electronic products, a touch device and a liquid crystal display panel are generally integrated to save a space required by a keyboard or control buttons, so as to expand a configurable area of a screen.

Generally, the touch panel should be assembled on the surface of the electronic product for being touched by the user to perform input and other operations. Alternatively, the touch panel is combined with the display panel to provide the functions of touch control and display. However, in order to shield the positions of the wires and circuit layout, the light shielding material with dark color, such as black, is disposed on the border of the touch panel. Thus, the border of the touch panel is usually black and does not satisfy the requirements of the colorful appearance of the product made by the users.

### SUMMARY OF THE INVENTION

The present invention provides a touch panel capable of providing color border in order to satisfy the requirement of the product appearance made by the user.

The invention provides a touch panel having an operation area and a periphery area surrounding the operation area. The touch panel comprises a substrate, a touch element, a complex non-conductive layer and a light shielding layer. The touch element is disposed on the substrate and located in the operation area. The complex non-conductive layer is disposed on the substrate and located at least in the periphery area. The complex non-conductive layer is formed by stacking a plurality of non-conductive layers and the non-conductive layers which are adjacent to each other are made of different materials. The light shielding layer is disposed on the substrate and located in the periphery area. The non-conductive layers are located at a side of the light shielding layer adjacent to the substrate.

Accordingly, in the touch panel of the present invention, the complex non-conductive layer is disposed over the light shielding layer. Since the indexes of refraction of different non-conductive layers in the complex non-conductive layer are different from one another, the border of the touch panel reveals colors. Thus, the touch panel of the present invention satisfies demands for product appearance made by the users.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view showing a touch panel according to one embodiment of the invention.

FIG. 2A is a top view schematically showing a touch panel according to a first embodiment of the invention.

FIG. 2B is a cross-sectional view of the touch panel shown in FIG. 2A along a line I-I′.

FIG. 3 is a schematic view showing a complex non-conductive layer according to one embodiment of the present invention.

FIG. 4 is a schematic view showing a complex non-conductive layer according to another embodiment of the present invention.

FIG. 5 is a cross-sectional view showing a touch panel according to a second embodiment of the invention.

FIG. 6 is a cross-sectional view showing a touch panel according to a third embodiment of the invention.

FIG. 7 is a cross-sectional view showing a touch panel according to a fourth embodiment of the invention.

FIG. 8 is a cross-sectional view showing a touch panel according to a fifth embodiment of the invention.

FIG. 9 is a cross-sectional view showing a touch panel according to a sixth embodiment of the invention.

### DESCRIPTION OF THE PREFERRED EMBODIMENTS

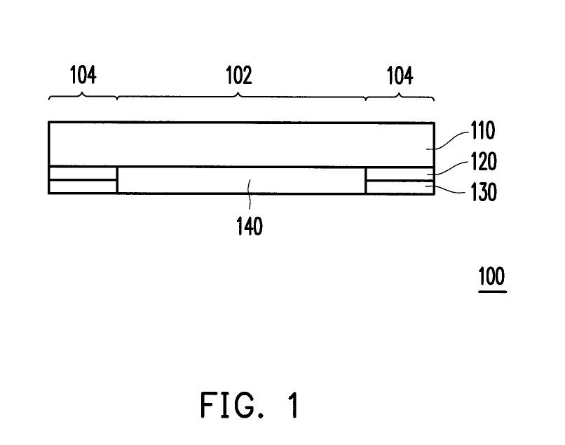

FIG. 1 is a schematic cross-sectional view showing a touch panel according to one embodiment of the invention. The touch panel 100 has an operation area 102 and a periphery area 104 surrounding the operation area 102. Specifically, the touch panel 100 comprises a substrate 110, a complex non-conductive layer 120, a light shielding layer 130 and a touch element 140. The touch element 140 can be composed of a single layer of conductive layer, a plurality of sensing series or a plurality of independent sensing units. The touch element 140 composed of a plurality of sensing series is used as an exemplar in the following embodiments for describing the design of the touch panel 100 and the present invention is not limited thereto.

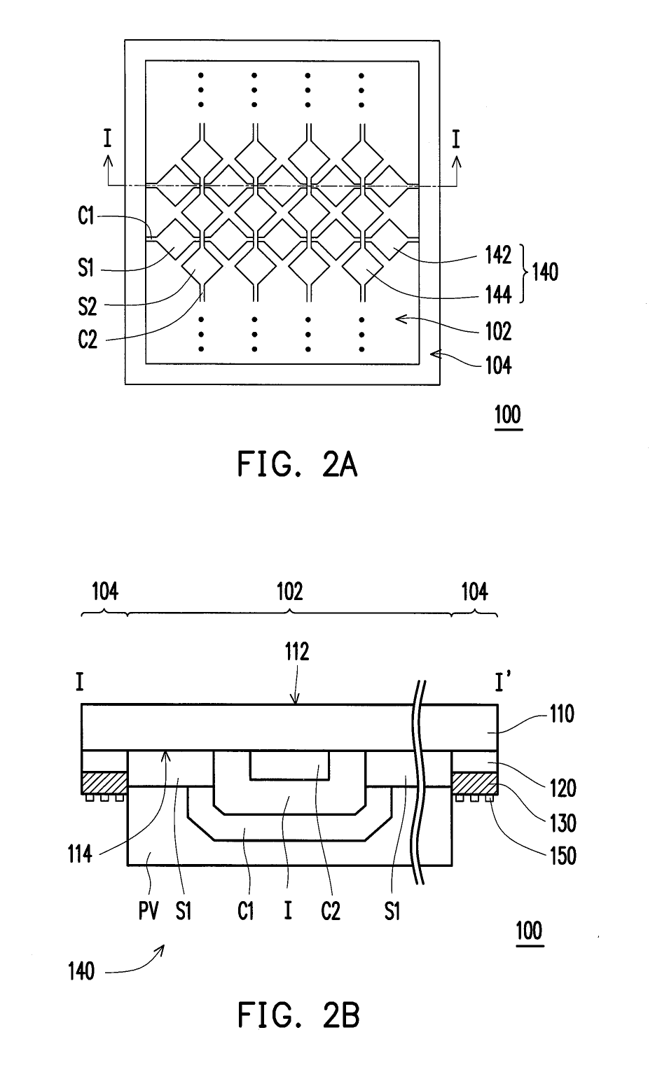

FIG. 2A is a top view schematically showing a touch panel according to a first embodiment of the invention and FIG. 2B is a cross-sectional view of the touch panel shown in FIG. 2A along a line I-I′. As shown in FIG. 2A and FIG. 2B, the touch panel 100 has an operation area 102 and a periphery area 104 surrounding the operation area 102. Specifically, the touch panel 100 comprises a substrate 110, a complex non-conductive layer 120, a light shielding layer 130 and a touch element 140. The touch element 140 is disposed on the substrate 110 and located in the operation area 102. The complex non-conductive layer 120 is disposed on the substrate 110 and located at least in the periphery area 104. The light shielding layer 130 is disposed on the substrate 110 and located in the periphery area 104. The complex non-conductive layer 120 is located at a side of the light shielding layer 130 adjacent to the substrate 110.

In the present embodiment, the substrate 110, for example, has a first side 112 and a second side 114 opposite to the first side 112. The substrate 110 can be plastic substrate, glass substrate or cover glass. When the user touches the touch panel 100, for example, on the first side 112, the touch element 140, the light shielding layer 130 and the complex non-conductive layer 120 are all located, for example, on the second side 114 of the substrate 110. However, the present invention is not limited thereto. In other embodiments, the light shielding layer 130 and the complex non-conductive layer 120 can be optionally disposed at the first side 112 of the substrate 110.

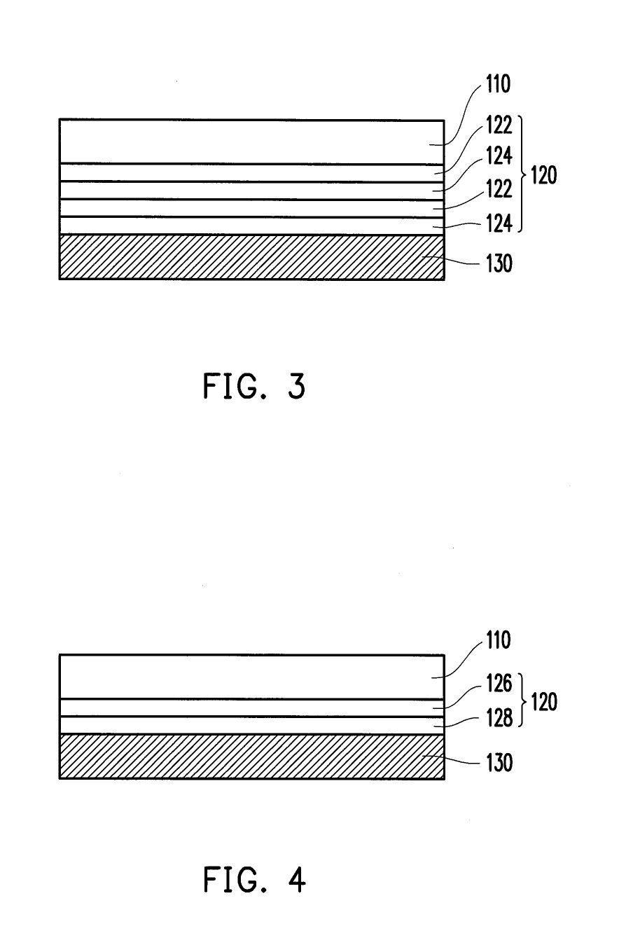

Furthermore, the complex non-conductive layer 120 can be formed by, for example, stacking a plurality of non-conductive layers and the adjacent non-conductive layers are made of different materials. The total thickness of the complex non-conductive layer 120 is, for example, less than 500 nm and even smaller than 300 nm. Also, the optical density (OD) of the complex non-conductive layer 120 is, for example, larger than 3. More clearly, FIG. 3 is a schematic view showing a complex non-conductive layer according to one embodiment of the present invention. As shown in FIG. 2B and FIG. 3, the complex non-conductive layer 120 is comprised of at least a first non-conductive layer 122 and at least a second non-conductive layer 124. It should be noticed that the structure of the complex non-conductive layer of the present embodiment does not limit the number of the non-conductive layers of the present invention. In the present embodiment, the at least first non-conductive layer 122 and the at least second non-conductive layer 124 are stacked alternately and are disposed between the substrate 110 and the light shielding layer 130. Also, among the at least first non-conductive layer 122 and the at least second non-conductive layer 124, the one which is the most close to the substrate 110 is the first non-conductive layer 122. Practically, at least the first non-conductive layer 122 and the at least second non-conductive layer 124 are alternately disposed at a side of the light shielding layer 130 adjacent to the substrate 110. On the other words, the at least first non-conductive layer 122 and the at least second non-conductive layer 124 are stacked alternately over the light shielding layer 130.

The index of refraction of the first non-conductive layer 122 is, for example, different from that of the second non-conductive layer 124 and the first non-conductive layer 122 and the second non-conductive layer 124 are stacked on one another in sequence. It should be noticed that the index of refraction of the first non-conductive layer 122 can be larger than the index of refraction of the second non-conductive layer 124. The first non-conductive layer 122 can be made of titanium oxide (TiO₂). Niobium oxide (Nb₂O₅), tantalum oxide (Ta₂O₅) or zirconium oxide (ZrO₂) and the second non-conductive layer 124 can be made of silicon oxide (SiO₂) or aluminum oxide (Al₂O₃).

In the present embodiment, the first non-conductive layer 122 and the second non-conductive layer 124 can be formed on the substrate 110 by, for example, the non-metal vacuum metalization (NMVM). Thus, the total thickness of the complex non-conductive layer 120 is small and can be smaller than 300 nm so that the thickness of the periphery area 104 of the touch panel 100 is not obviously increased. Moreover, the indexes of refraction of the first non-conductive layer 122 and the second non-conductive layer 124 are different from each other and the first non-conductive layer 122 and the second non-conductive layer 124 are alternately stacked on one another. Hence, the arrangement of the complex non-conductive layer 120 and the light shielding layer 130 leads to the assembly of the complex non-conductive layer 120 and the light shielding layer 130 revealing a specific color after reflecting the external incident light.

More specifically, after entering the substrate 110, the external light passes through the complex non-conductive layer 120. The indexes of refraction of the first non-conductive layer 122 and the second non-conductive layer 124 in the complex non-conductive layer 120 are different from each other and the first non-conductive layer 122 and the second non-conductive layer 124 are alternately stacked on one another. Hence, a portion of the light is reflected and a portion of the light is refracted at the interface between the first non-conductive layer 122 and the second non-conductive layer 124. Then, the light is reflected to the outside by the light shielding layer 130. Meanwhile, there is an optical path difference existing between the reflected light from different interfaces between the first non-conductive layer 122 and the second non-conductive layer 124 and the reflected light from the light shielding layer 130. The reflected lights with optical path difference therebetween interfere with each other so that the user perceives the light with a specific wavelength which reveals a specific color. Therefore, the touch panel 100 has a color periphery area 104 and the color of the periphery area 104 has an ideal color saturation.

In one embodiment, the color of the periphery area 104 is varied with the materials and the thicknesses of the first non-conductive layer 122 and the second non-conductive layer 124. For instance, when the first non-conductive layer 122 is made of titanium oxide, the second non-conductive layer 124 is made of silicon oxide, the thicknesses of the film layers of the complex non-conductive layer 120 are 48 nm, 94 nm, 69 nm and 94 nm respectively, the color of the periphery area 104 can be blue. When the materials of the first non-conductive layer 122 and the second non-conductive layer 124 remain unchanged and the thicknesses of the film layers of the complex non-conductive layer 120 are 40 nm, 90 nm, 94 nm and 114 nm respectively, the color of the periphery area 104 is green. Furthermore, when the thicknesses of the film layers of the complex non-conductive layer 120 are 40 nm, 80 nm, 104 nm and 45 nm respectively, the color of the periphery area 104 is red. The designer can design the touch panels 100 with different color periphery area 104 for the users by adjusting the materials and the thicknesses of the first non-conductive layer 122 and the second non-conductive layer 124.

Moreover, FIG. 4 is a schematic view showing a complex non-conductive layer according to another embodiment of the present invention. As shown in FIG. 2B and FIG. 4, the complex non-conductive layer 120 comprises, for example, a first non-conductive layer 126 and a second non-conductive layer 128. That is, the complex non-conductive layer 120 of the present embodiment is practically composed of two non-conductive layers. In the present embodiment, the first non-conductive layer 126 is made of, for example, stannum and the second non-conductive layer 128 is made of, for example, stannum oxide. It should be noticed that although the first non-conductive layer 126 is made of stannum, it is still non-conductive due to that the thickness of the first non-conductive layer 126 is smaller than 40 nm. That is, in the view of microcosm, the first non-conductive layer 126 made of stannum with a relatively small thickness is in the form of discontinuous island structure. Hence, the first non-conductive layer 126 is electrically nonconductor. Therefore, the coupling between the stannum layer (which is the first non-conductive layer 126) and the touch element 140 and the electrical interference can be avoided.

In the present embodiment, the first non-conductive layer 126 and the second non-conductive layer 128 can be formed on the substrate 110 by, for example, non-conductive vacuum metallization (NCVM). The first non-conductive layer 126 can, for example, reflect a portion of the external incident light and the light shielding layer 130 also reflects the external incident light. Since there is an optical path difference between the reflected light from the first non-conductive layer 126 and the reflected light from the light shielding layer 130, the user can perceive colorful peripheray area 104 of the touch panel 100 under the interference of the two reflected lights. Moreover, in the present embodiment, the thickness of the first non-conductive layer 126 determines the proportion of the light reflected light from the first non-conductive layer 126 and the thickness of the second non-conductive layer 128 determines the color of the periphery area 104. Also, since the first non-conductive layer 126 is made of metal tannum, the periphery area 104 of the touch panel 100 having the complex non-conductive layer 120 composed of the first non-conductive layer 126 and the second non-conductive layer 128 reveals metallic luster.

In addition, as shown in FIG. 2A and FIG. 2B, the light shielding layer 130 can be, for example, an ink layer, a light shielding resin layer, a light shielding photoresist layer, a silicon carbide layer (SiC layer), a diamond like carbon layer or other film layers made of light shielding materials. Furthermore, in the touch panel 100 of the present embodiment, for example, the touch element 140 is composed of a plurality of first sensing series 142 and a plurality of second sensing series 144. Each of the first sensing series 142 comprises a plurality of sensing pads S1 and a plurality of connecting lines C1. The connecting lines C1 connects the sensing pads S1 in a series along a direction. Each of the second sensing series 144 comprises a plurality of sensing pads S2 and a plurality of connecting lines C2. The connecting lines C2 connects the sensing pads S2 in a series along another direction. In order to avoid the first sensing series 142 from being short with the second sensing series 144, for each of the connecting lines C1 and each of the connecting lines C2, an insulating pattern I is disposed between the connecting lines C1 and the connecting lines C2. It should be noticed that, in FIG. 2B, one insulating pattern I between the connecting lines C1 and C2 in the touch panel 100 is shown as an exemplary embodiment of the present invention. Also, the touch element 140 comprises a passivation layer PV covering the first sensing series 142 and the second sensing series 144.

In the present invention, the sensing pads S1 and the second sensing series 144 can be made of the same transparent conductive material layers. Then, the insulating patterns I are formed on the connecting lines C2. Thereafter, the connecting lines C1 are formed on the insulating patterns I while the connecting lines C1 are located at a side of the insulating patterns I away from the substrate 110. Finally, the passivation layer PV is formed on the first sensing series 142 and the second sensing series 144. Nevertheless, the present invention is not limited thereto.

In other embodiments, before the sensing pads S1 and the second sensing series 144 are formed, the connecting lines C1 can be formed on the substrate 110 in advance. Further, after the insulating patterns I are formed on the connecting lines C1, the sensing pads S1 and the second sensing series 144 are formed on the substrate 110. Hence, the connecting lines C1 can be located between the insulating patterns I and the substrate 110. Finally, the passivation layer PV is formed on the first sensing series 142 and the second sensing series 144. In one embodiment, each of the insulating patterns I can be an insulating layer having an opening and the opening exposes two ends of the connecting lines C1 so that the connecting lines C1 can electrically connect to the sensing pads S1. Also, each of the insulating patterns I can be an island insulating pattern which is arranged to be corresponding to the positions of the connecting lines C1 and exposes two ends of the connecting lines C1 so that the connecting lines C1 can electrically connect to the sensing pads S1.

Altogether, the formation orders of the sensing pads S1 and S2 and the connecting lines C1 and C2 are not limited to in the present embodiment. That is, as long as the first sensing series 142 and the second sensing series 144 composed of the sensing pads S1 and S2 and connecting lines C1 and C2, the touch element composed of the first sensing series 142 and the second sensing series 144 conforms to the inventive spirit of the present embodiment. Further, in order to connect the first sensing series 142 and the second sensing series 144 to the driving circuit or the external circuit, the touch panel 100 also comprises a plurality of conductive wires 150 disposed on the substrate 110 and located in the periphery area 104. The conductive wires 150 are electrically connected to the touch element 140 and are located at a side of the light shielding layer 130 away from the substrate 110. Therefore, the light shielding layer 130 shields the conductive wires 150 to maintain the artistic appearance of the touch panel 100.

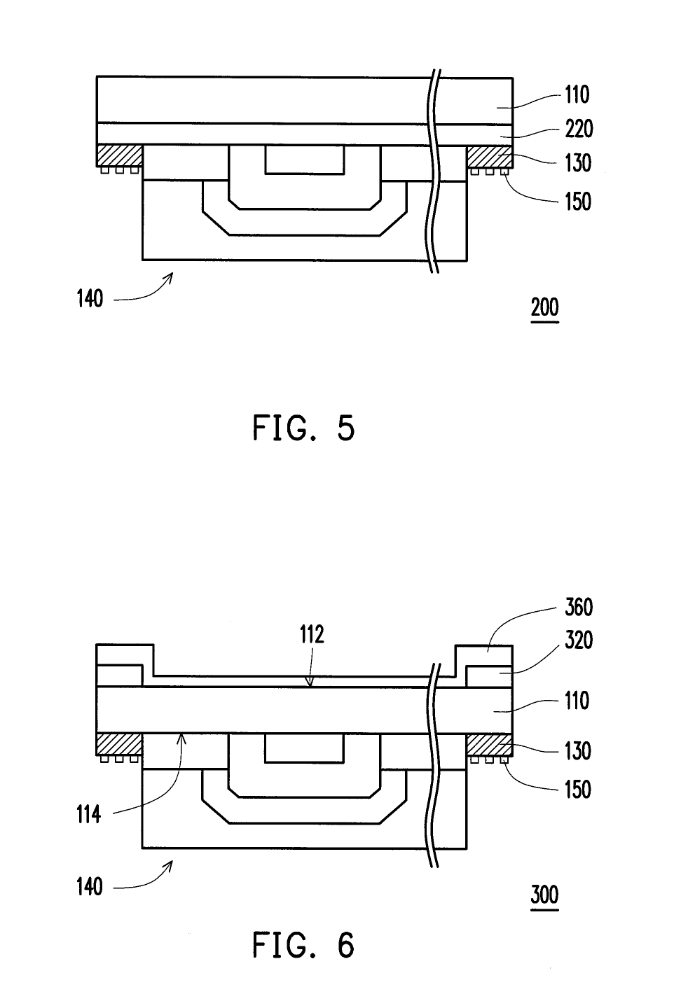

FIG. 5 is a cross-sectional view showing a touch panel according to a second embodiment of the invention. As shown in FIG. 5, the touch panel 200 is similar to the touch panel 100 and the same elements in the touch panel 200 and the touch panel 100 are labeled with the same reference numbers and are not further described herein. The main difference between the touch panel 200 and the touch panel 100 is that, in the touch panel 200, the complex non-conductive layer 220 is disposed not only at the periphery area 104 but also in the operation area 102. On the other words, the complex non-conductive layer 220 of the present embodiment is entirely disposed on the substrate 110 and is not disposed only at the periphery area 104.

FIG. 6 is a cross-sectional view showing a touch panel according to a third embodiment of the invention. As shown in FIG. 6, the touch panel 300 is similar to the touch panel 100 so that the same elements in the touch panel 300 and the touch panel 100 are labeled with the same reference numbers and are not described herein. The main difference between the touch panel 300 and the touch panel 100 is that, in the touch panel 300, the complex non-conductive layer 320 is disposed at the first side 112 of the substrate 110 and the touch panel 300 further comprises a hard coating layer 360. The hard coating layer 360 is disposed at the first side 112 of the substrate 110 away from the touch element 140 and covers the complex non-conductive layer 320 to prevent the complex non-conductive layer 320 from being scraped.

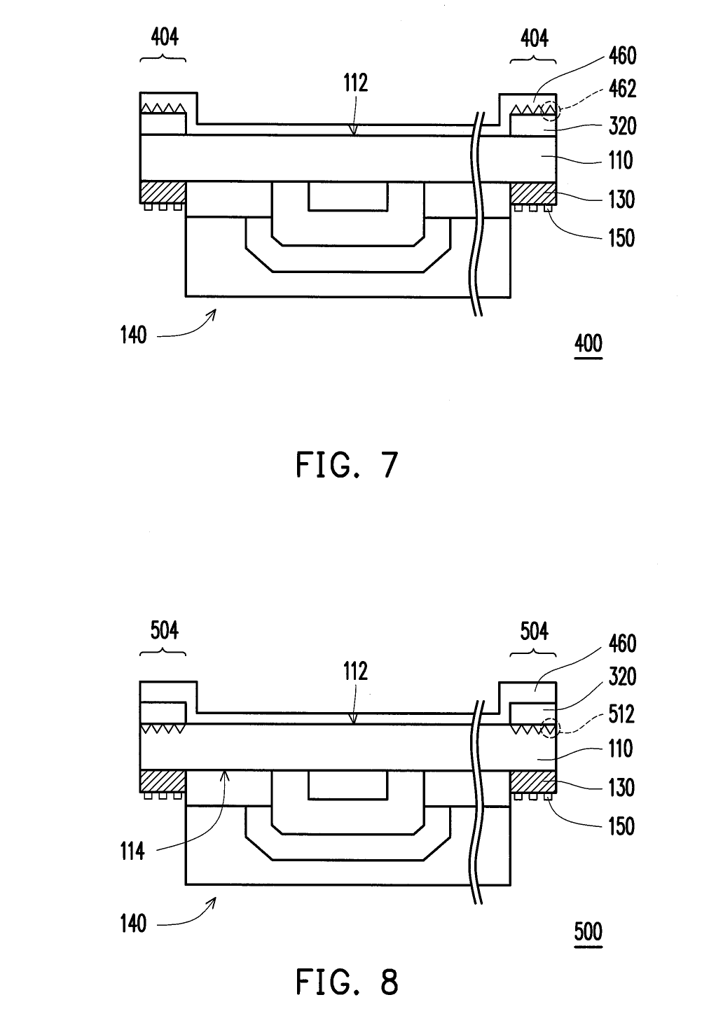

FIG. 7 is a cross-sectional view showing a touch panel according to a fourth embodiment of the invention. As shown in FIG. 7, the touch panel 400 is similar to the touch panel 300 so that the same elements in the touch panel 400 and the touch panel 300 are labeled with the same reference numbers and are not described herein. The main difference between the touch panel 400 and the touch panel 300 is that, in the periphery area 404, the touch panel 400 further comprises a plurality of micro-prism structures 462 disposed on the hard coating layer 460 to reflect or refract the incident light such that the border of the touch panel 400 reveals prism-like veins with three-dimensional vision, metal tactile sensation and metallic luster.

FIG. 8 is a cross-sectional view showing a touch panel according to a fifth embodiment of the invention. As shown in FIG. 8, the touch panel 500 is similar to the touch panel 400 so that the same elements in the touch panel 500 and the touch panel 400 are labeled with the same reference numbers and are not described herein. The main difference between the touch panel 500 and the touch panel 400 is that the plural micro-prism structures 512 in the periphery area 504 of the touch panel 500 are formed at the first side 112 of the substrate 110 by the patterning steps such as laser graving or etching process.

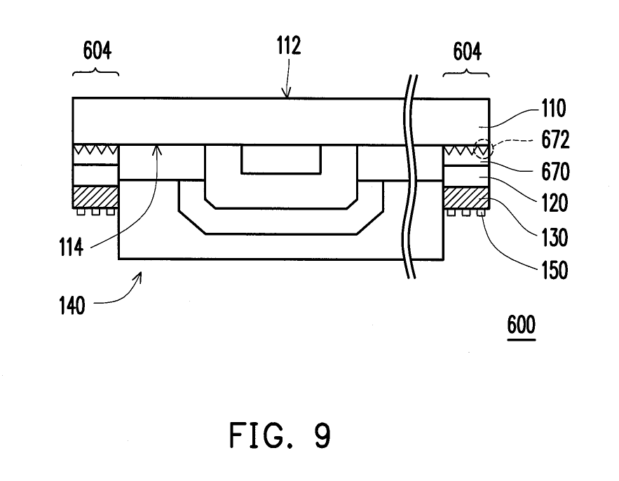

FIG. 9 is a cross-sectional view showing a touch panel according to a sixth embodiment of the invention. As shown in FIG. 9, the touch panel 600 is similar to the touch panel 100 so that the same elements in the touch panel 600 and the touch panel 100 are labeled with the same reference numbers and are not described herein. The main difference between the touch panel 600 and the touch panel 100 is that in the periphery area 604, the touch panel 600 further comprises a hard coating layer 670 having a plurality of micro-prism structures 672. The micro-prism structures 672 are disposed between the substrate 110 and the complex non-conductive layer 120.

Accordingly, in the present invention, the complex non-conductive layer disposed over the light shielding layer is formed by stacking layers made of different materials. There is an optical path difference between the reflected lights respectively from the complex non-conductive layer and the light shielding. Hence, due to the interference between the reflected lights, the periphery area of the touch panel in which the complex non-conductive layer and the light shielding layer are disposed reveals colors. Therefore, the appearance of the touch panel can be various and can satisfy the demands for colorful product appearance made by the users.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A touch panel having an operation area and a periphery area surrounding the operation area, the touch panel comprising:
a substrate;
a touch element disposed on the substrate and located in the operation area;
a complex non-conductive layer disposed on the substrate and at least located within the periphery area, and formed by stacking a plurality of non-conductive layers; and
a light shielding layer disposed on the substrate and located in the periphery area, wherein the complex non-conductive layer is located at a side of the light shielding layer adjacent to the substrate.

2. The touch panel of claim 1, wherein the touch element and the complex non-conductive layer are all located at a side of the substrate adjacent to the light shielding layer.

3. The touch panel of claim 2, further comprising a hard coating layer disposed at a side of the substrate adjacent to the touch element and located in the periphery area.

4. The touch panel of claim 3, wherein the hard coating layer further comprises a plurality of micro-prism structures corresponding to the complex non-conductive layer.

5. The touch panel of claim 1, wherein the touch element is located at a side of the substrate adjacent to the light shielding layer and the complex non-conductive layer is located at a side of the substrate away from the light shielding layer.

6. The touch panel of claim 5, further comprising a hard coating layer disposed at a side of the substrate away from the touch element, and located in the operation area and the periphery area.

7. The touch panel of claim 6, wherein the hard coating layer further comprises a plurality of micro-prism structures corresponding to the complex non-conductive layer.

8. The touch panel of claim 6, wherein the substrate further comprises a plurality of micro-prism structures corresponding to the complex non-conductive layer.

9. The touch panel of claim 1, wherein the complex non-conductive layer comprises at least a first non-conductive layer and at least a second non-conductive layer, and the at least first non-conductive layer and the at least second non-conductive layer are alternately disposed at a side of the light shielding layer adjacent to the substrate.

10. The touch panel of claim 9, wherein the at least second non-conductive layer is much closer to the light shielding layer than the at least first non-conductive layer is.

11. The touch panel of claim 10, wherein the at least first non-conductive layer is made of tin and the at least second non-conductive layer is made of tin oxide.

12. The touch panel of claim 10, wherein an index of refraction of the at least first non-conductive layer is larger than an index of refraction of the at least second non-conductive layer.

13. The touch panel of claim 1, wherein the touch element comprises a plurality of first sensing series and a plurality of second sensing series, each of the first sensing series comprises a plurality of first sensing pads and a plurality of first connecting lines connecting the first sensing pads in a series along a first direction, each of the second sensing series comprises a plurality of second sensing pads and a plurality of second connecting lines connecting the second sensing pads in a series along a second direction and the first sensing series and the second sensing series are electrically independent from each other.

14. The touch panel of claim 13, wherein the first sensing pads and the second sensing series are substantially formed by the same material layer, and the touch element further comprises a plurality of insulating patterns disposed between the first connecting lines and the second connecting lines.

15. The touch panel of claim 14, wherein the first connecting lines are disposed between the insulating patterns and the substrate.

16. The touch panel of claim 14, wherein the first connecting lines are disposed at a side of the insulating layer away from the substrate.

17. The touch panel of claim 1, further comprising a plurality of conductive wires disposed on the substrate and located in the periphery area, wherein the conductive wires are connected to the touch element.

18. The touch panel of claim 17, wherein the conductive wires are disposed on a side of the light shielding layer away from the substrate.

19. The touch panel of claim 1, wherein light shielding layer includes an ink layer, a light shielding resin layer, a light shielding photoresist layer, a silicon carbide layer (SiC layer) or a diamond like carbon layer.
